(19) United States
(12) Patent Application Publication
(10) Pub. No.: US 2026/0165222 A1
(43) Pub. Date: Jun. 18, 2026

(54) VEHICLES, METHODS AND NON-TRANSITORY COMPUTER-READABLE MEDIA FOR DYNAMIC OPERATING BOUNDARY GENERATION

(71) Applicant: Deere & Company, Moline, IL (US)

(72) Inventors: Michael R. WHITE, Polk City, IA (US); Hans W. SCHAEFFER, Urbandale, IA (US); Eric R. ANDERSON, Ames, IA (US); Ryan C. BURNLEY, Ankeny, IA (US); Madaline E. MUSHABEN BUTH, West Fargo, ND (US); Kelsey CULP, West Des Moines, IA (US)

(73) Assignee: Deere & Company, Moline, IL (US)

(21) Appl. No.: 18/982,268

(22) Filed: Dec. 16, 2024

(51) Int. Cl. A01B 69/00; A01B 69/04; A01D 41/127

(52) U.S. Cl. CPC A01B 69/001; A01B 69/008; A01D 41/1278

(57) ABSTRACT

Vehicles, methods, and non-transitory computer-readable media are provided for dynamic operating boundary generation. A vehicle including a steering actuator, and processing circuitry configured to cause the follower vehicle to determine a position of an obstacle to the follower vehicle, generate an operating boundary of the follower vehicle based on the position of the obstacle, a relative position of the follower vehicle to a leader vehicle, and characteristics of the follower vehicle and the leader vehicle, and control a steering angle of the steering actuator based on the operating boundary.

### FIELD OF THE DISCLOSURE

Some example embodiments provide vehicles, methods, and non-transitory computer-readable media for dynamically generating an operating boundary between vehicles.

### BACKGROUND

In agricultural and/or industrial operations involving coordination between two or more vehicles, the vehicles travel through an operational area in proximity with one another. In such scenarios, guidance systems of the vehicles control the vehicles to avoid or reduce the likelihood of collisions between the vehicles.

### SUMMARY

Some example embodiments provide improved vehicles, methods, and non-transitory computer-readable media for dynamically generating an operating boundary between vehicles based on perception information.

Some example embodiments provide a vehicle including a steering actuator, and processing circuitry configured to cause the follower vehicle to determine a position of an obstacle to the follower vehicle, generate an operating boundary of the follower vehicle based on the position of the obstacle, a relative position of the follower vehicle to a leader vehicle, and characteristics of the follower vehicle and the leader vehicle, and control a steering angle of the steering actuator based on the operating boundary.

Some example embodiments provide a method including determining a position of an obstacle to a follower vehicle, generating an operating boundary of the follower vehicle based on the position of the obstacle, a relative position of the follower vehicle to a leader vehicle, and characteristics of the follower vehicle and the leader vehicle, and controlling a steering angle of a steering actuator based on the operating boundary.

Some example embodiments provide a system including a non-transitory computer-readable medium storing instructions that, when executed by at least one processor of a follower vehicle, cause the at least one processor to perform a method, the method including determining a position of an obstacle to the follower vehicle, generating an operating boundary of the follower vehicle based on the position of the obstacle, a relative position of the follower vehicle to a leader vehicle, and characteristics of the follower vehicle and the leader vehicle, and controlling a steering angle of a steering actuator based on the operating boundary.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For the purposes of clarity, various dimensions of the drawings may have been exaggerated.

FIG. 1A illustrates a plan view of a leader vehicle and a follower vehicle that are aligned for transferring of material from the leader vehicle to the follower vehicle, in accordance with some example embodiments;

FIG. 1B illustrates a vehicle, in accordance with some example embodiments;

FIG. 2 illustrates a diagram of system, according to some example embodiments;

FIGS. 3A and 3B illustrate example scenarios of operating boundary generation by a follower vehicle following a leader vehicle;

FIG. 4 illustrates a scenario for collaborative operations with multiple vehicles including two or more follower vehicles, according to some example embodiments; and

FIG. 5 illustrates a method for generating an operating boundary of a follower vehicle, according to some example embodiments.

### DETAILED DESCRIPTION

Some example embodiments described herein relate to agricultural and/or industrial operations involving coordination between multiple vehicles. In an illustrative example, the operations may involve transferring or unloading material (e.g., agricultural material) between two vehicles (e.g., moving vehicles). The vehicles may include a leader vehicle (e.g., combine or harvesting machine) and follower vehicle (e.g., a combine and grain cart, wagon, etc.) that are both moving. The material may be transferred from the leader vehicle to the follower vehicle via an auger of the leader vehicle. The agricultural material may include grain, corn, soybeans, legumes, nuts, vegetables, fruits, potatoes, tubers, oilseeds, fiber and/or other harvested plant material. The material may include the agricultural material, minerals, metals, oil, tar sands, shale, raw petroleum products, mined material, ores, soil, sand, clay, stones, crushed rock, gravel, peat, organic matter, animal waste and/or other material. In operations in which the materials are transferred from the leader vehicle to the follower vehicle via an auger of the leader vehicle, the follower vehicle is controlled to maintain a specific relative distance from the leader vehicle that positions the follower vehicle underneath an outlet of the auger. To aid in conciseness of description, the below discussion will mainly refer to the agricultural and/or industrial operations in the context of the above illustrated example, but some example embodiments are not limited thereto and the agricultural and/or industrial operations may involve any operations in which multiple vehicles coordinate.

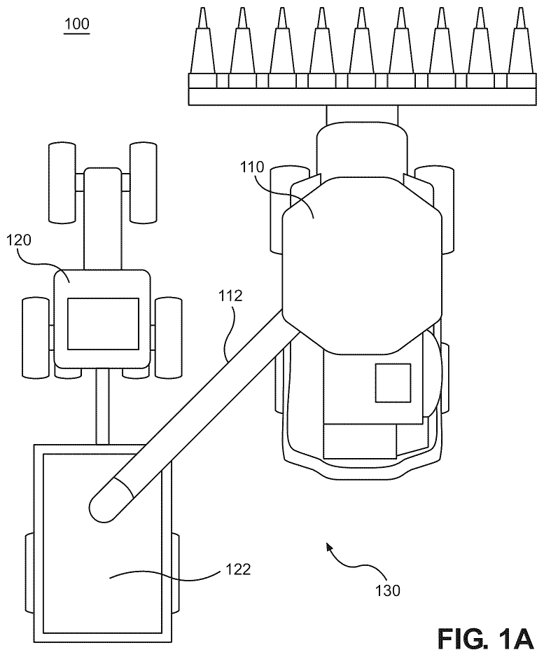

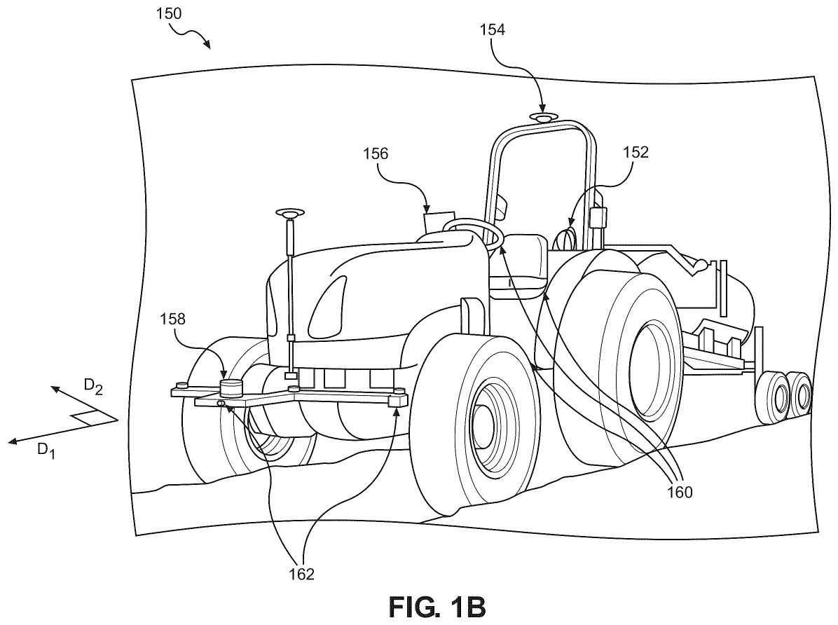

FIG. 1 illustrates a plan view of a leader vehicle and a follower vehicle that are aligned for transferring of material from the leader vehicle to the follower vehicle, in accordance with some example embodiments.

Referring to FIG. 1, a system 100 includes a leader vehicle 110 and a follower vehicle 120, according to some example embodiments. As illustrated in FIG. 1, the leader vehicle 110 is a harvester transferring agricultural material to a wagon, however, some example embodiments are not limited thereto. According to some example embodiments, the leader vehicle 110 and/or the follower vehicle 120 may be implemented by any type of moving vehicle, and the material transferred may include any type of material capable of being transferred according to the example implementations described herein. Also, while FIG. 1 illustrates a pair of vehicles, some example embodiments are not limited thereto. According to some example embodiments, the system 100 may include more than two vehicles transferring material among one another. Also, some example embodiments are not limited to operations involving material transfer between the vehicles. For instance, according to some example embodiments, the vehicles may perform any operation in which relative positions between the vehicles are relevant for coordination among the vehicles. Nonetheless, the example of a pair of vehicles transferring agricultural material will mainly be discussed below for added clarity of description of some example embodiments.

The leader vehicle 110 and the follower vehicle 120 may be moving (e.g., driving) in a generally common (e.g., forward) direction in a work area (e.g., a field) 130. The leader vehicle 110 includes an auger 112 that may transfer the agricultural material to the follower vehicle 120 under the control of the leader vehicle 110. The follower vehicle 120 may include an open container 122 configured to receive the agricultural material from the leader vehicle 110.

FIG. 1B illustrates a vehicle, in accordance with some example embodiments.

Referring to FIG. 1B, depicted is a side view of a vehicle 150. According to some example embodiments, either or both of the leader vehicle 100 and/or the follower vehicle 120 may be implemented by the vehicle 150. In FIG. 1B, the vehicle is illustrated as being a tractor with a sprayer attached to the rear of the tractor, however some example embodiments are not limited thereto. According to some example embodiments, the vehicle 150 may be a harvester (e.g., a combine harvester, etc.), a self-propelled sprayer, a windrower, a tractor (with or without a front or rear implement attached), or any other vehicle. For example, the vehicle 150 may be any vehicle for use in performing agricultural and/or industrial operations. The vehicle 150 may include a processing apparatus 152, an on-board user interface 156 (e.g., including a touchscreen), steering, pedal and implement actuators 160 (e.g., a steering actuator(s), a pedal actuator(s) and/or an implement actuator(s)) configured to control the vehicle 150 (and/or any implements attached thereto) via a manual control interface of the tractor, a global positioning system (GPS) receiver 154 mounted on the cab of the vehicle 150, one or more perception sensors 158, and/or e-stops 162 configured to shut down the vehicle 150 when they are pressed or activated (collectively referred to herein as the components of the vehicle 150). However, some example embodiments are not limited to, and the vehicle 150 may include additional and/or fewer components relative to those mentioned above. According to some example embodiments, the vehicle 150 may be autonomous (e.g., fully autonomous or partially autonomous), but some example embodiments are not limited thereto and the vehicle 150 may be controlled (e.g., at least partially controlled) by an operator. One or more implements may be attached (e.g., removably attached) to the vehicle 150. For example, types of the implements may include tillers, seeders, planters, sprayers, harvesting blades, cutters, mowers, shredders, rippers, various types of harvester headers (e.g., for harvesting corresponding types of crops such as sugar, cotton, etc.), or any other implements (e.g., any other implements for performing an agricultural and/or industrial operation). Implements may be removably attached to a tractor or any other vehicle 150 (e.g., the harvester, the self-propelled sprayer, the windrower, etc.). According to some example embodiments, each of the types implements may also be implemented as a corresponding self-propelled vehicle 150 (e.g., a tiller vehicle, a seeder vehicle, a planter vehicle, a sprayer vehicle, a harvester vehicle, a cutter vehicle, a mower vehicle, a shredder vehicle, a ripper vehicle, etc.).

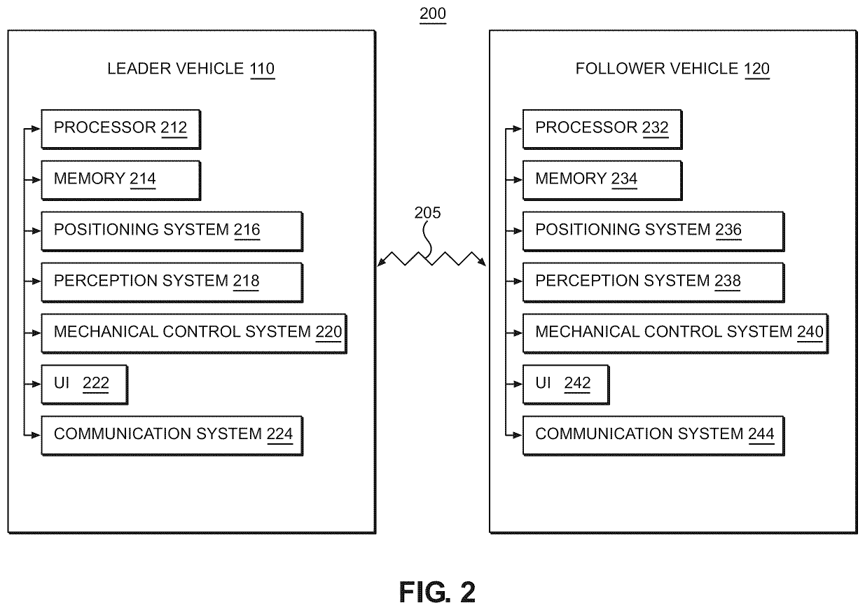

FIG. 2 illustrates a diagram of a system, according to some example embodiments.

Referring to FIG. 2, a system 200 may include the leader vehicle 110 and the follower vehicle 120. The leader vehicle 110 may include a processor 212, a memory 214, a positioning system 216, a perception system 218, a mechanical control system 220, a user interface (UI) 222 and/or a communication system 224 (collectively referred to herein as the components of the leader vehicle 110). According to some example embodiments, the system 200 may include more vehicles than those discussed above. According to some example embodiments, the leader vehicle 110 may include more or fewer components than those discussed above.

The processor 212 (e.g., the processing apparatus 152) may control overall operation of the leader vehicle 110. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The processor 212 may store and/or retrieve data to and/or from the memory 214 (e.g., programming instructions for execution by the processor 212, operational data generated by the processor 212, etc.). The processor 212 may receive communication signals from the communication system 224 and/or provide communication signals to the communication system 224. The processor 212 may receive a current position of the leader vehicle 110 from the positioning system 216. The processor 212 may generate and send control signals for controlling the positioning system 216, the perception system 218, the UI 222, the mechanical control system 220 and/or the communication system 224.

The memory 214 may be a tangible, non-transitory computer-readable medium, such as a Random Access Memory (RAM), a flash memory, a Read Only Memory (ROM), an Electrically Programmable ROM (EPROM), an Electrically Erasable Programmable ROM (EEPROM), registers, a hard disk, a removable disk, a Compact Disk (CD) ROM, any combination thereof, or any other form of storage medium known in the art. The memory 214 may store data and/or instructions for retrieval by, for example, the processor 212.

The positioning system 216 may receive one or more signals representative of a current position of the leader vehicle 110 and/or information from which the current position of the leader vehicle 110 may be calculated (e.g., by the positioning system 216 and/or the processor 212). As referred to herein, the current position of the leader vehicle 110 (also referred to herein as position data) may include two-dimensional coordinates (e.g., Northing and Easting), a time (e.g., timestamp) corresponding to the current position of the leader vehicle 110, a heading of the leader vehicle 110, a velocity of the leader vehicle 110 and/or a yaw rate of the leader vehicle 110. According to some example embodiments, the positioning system 216 may include a receiver capable of receiving signals from a satellite navigation system (e.g., a Global Navigation Satellite System (GNSS)) such as, for example, the Global Positioning System (GPS), the Global Navigation Satellite System (GLONASS), the BeiDou Navigation Satellite System (BDS), etc. For example, the positioning system 216 may include a GPS receiver (e.g., the GPS receiver 154) and may receive the one or more signals from satellites of the GPS. According to some example embodiments, the positioning system 216 may include another GPS receiver on an attached implement, and may also (or alternatively) receive the one or more signals via the other GPS receiver, but some example embodiments are not limited thereto. According to some example embodiments, the positioning system 216 may provide position data including the current position of the leader vehicle 110 (e.g., the two-dimensional coordinates (e.g., Northing and Easting), the time corresponding to the current position of the leader vehicle 110, the heading of the leader vehicle 110, the velocity of the leader vehicle 110 and/or the yaw rate of the leader vehicle 110) to the processor 212 and/or the memory 214 at a periodic interval that may be predefined (or alternatively, given). According to some example embodiments, the positioning system 216 may be implemented using processing circuitry. The receiver of the positioning system 216 is mainly referred to herein as being the GPS receiver, but some example embodiments are not limited to, and any receiver of a navigation system (e.g., a GNSS) may be used. The receiver may be referred to herein as the GPS receiver for conciseness of description and references thereto do not limit the receiver of the positioning system 216 to only GPS-based implementations.

The perception system 218 (including, for example, the perception sensors 158) may include a LiDAR system and/or a camera system, but some example embodiments are not limited thereto. For example, the perception system 218 may include a sonar system, a radar system and/or any other sensor capable of detecting an obstacle (e.g., a boulder, another vehicle, a waterway, a fence, a tree, etc.) to the leader vehicle 110 that would be known to a person having ordinary skill in the art. The perception system 218 may detect one or more objects (e.g., a boulder, another vehicle, a waterway, a fence, a tree, etc.) that are obstacles to the leader vehicle 110. The perception system 218 may provide an indication of the one or more detected obstacles to the processor 212. The processor 212 may use the indication of the one or more detected obstacles for processing operations and/or store the indication in the memory 214. According to some example embodiments, the perception system 218 may be implemented using processing circuitry.

According to some example embodiments, the LiDAR system may include one or more LiDAR devices mounted on the leader vehicle 110. The one or more LiDAR devices may be mounted on a front of the leader vehicle 110 and be forward-looking (e.g., in a first direction D1 illustrated in FIG. 1B) with respect to the leader vehicle 110, but some example embodiments are not limited thereto, and the one or more LiDAR devices may be mounted anywhere on the leader vehicle 110 and pointed in any direction. According to some example embodiments, the one or more LiDAR devices may perform scanning using a laser to generate a point cloud. For example, the laser may be emitted in multiple directions and reflect off of objects (e.g., obstacles), and the one or more LiDAR devices (and/or the perception system 218) may determine ranges to the objects based on an amount of time measured for the reflected laser to reach the one or more LiDAR devices. The point cloud may include a plurality of points, each of which may be represented by three-dimensional coordinates (e.g., x, y and z coordinates) or two-dimensional coordinates (e.g., x and y coordinates), hereafter generally referred to as coordinates, but some example embodiments are not limited thereto. According to some example embodiments, each of the plurality of points may have additional attributes including a scan angle, a point density, a color value (e.g., red, green and blue values), a time stamp, etc. The perception system 218 may generate the point cloud may by determining respective coordinates for each among the plurality of points based on the amount of time measured with respect to each of the plurality of points. According to some example embodiments, the coordinates may be determined as global coordinates based on a current geospatial position of the leader vehicle 110 (e.g., obtained from the positioning system 216), however some example embodiments are not limited thereto, and the coordinates may be determined as relative coordinates with respect to the leader vehicle 110 (e.g., by setting the position of the leader vehicle 110 as coordinate 0, 0, 0). According to some example embodiments, the sonar system and/or radar system may generate similar point clouds based on emitted sound signals and/or radio waves, respectively.

According to some example embodiments, the camera system may include one or more stereo cameras mounted on the leader vehicle 110. The one or more stereo cameras may be mounted on a front of the leader vehicle 110 and be forward-looking with respect to the leader vehicle 110, but some example embodiments are not limited thereto, and the one or more stereo cameras may be mounted anywhere on the leader vehicle 110 and pointed in any direction. Each stereo camera among the one or more stereo cameras may capture one or more pairs of images. While the stereo camera is described herein as capturing pairs of images, some example embodiments are not limited thereto and the stereo camera may capture a series of single images, or may capture more than two images simultaneously (or contemporaneously). The perception system 218 may apply a stereo matching algorithm, such as a sum of absolute differences algorithm, a sum of squared differences algorithm, a consensus algorithm, etc., to determine one or more disparity values (e.g., difference values) between each pair of images. According to some example embodiments, the perception system 218 may generate a disparity map based on the one or more disparity values. The perception system 218 may estimate a distance (e.g., a range) to one or more objects (e.g., obstacles) captured in the images based on the one or more disparity values (and/or the disparity map). According to some example embodiments, the perception system 218 may generate a point cloud (e.g., a 2D point cloud or a 3D point cloud) based on the one or more disparity values (and/or the disparity map), and may estimate a distance between the leader vehicle 110 and a given object among the one or more objects based on a number of points in the point cloud. According to some example embodiments, the perception system 218 may generate the point cloud using any algorithm that would be known to persons having ordinary skill in the art. According to some example embodiments, the point cloud may include a model and/or representation of the one or more disparity values (and/or the disparity map).

The mechanical control system 220 may include one or more mechanical systems for controlling a movement and/or position of the leader vehicle 110. The mechanical control system 220 may include, for example, a steering actuator, a pedal actuator, an implement actuator, etc. (e.g., the steering, pedal and implement actuators 160). Each of the steering actuator, the pedal actuator and the implement actuator may be controlled according to corresponding control signals received from the processor 212. According to some example embodiments, the mechanical control system 220 may be implemented using processing circuitry.

According to some example embodiments, the steering actuator may mechanically move a support structure (e.g., wheels, tracks, etc.) of the leader vehicle 110 in either direction (e.g., left or right from the forward perspective of the leader vehicle 110, such as the first direction D1) in an amount corresponding to an updated steering angle included in a command from the processor 212. For example, the mechanical control system 220 may include a steering system, such as a hydraulic steering system, an electro-hydraulic steering system, an electromechanical steering system, an electromechanical actuator, an electrical steering system, a drive-by-wire steering system or another steering system with an electrical or electronic control interface for communicating with the processor 212. In some example embodiments, the electronic control interface may include a sensor for detecting a position of a hydraulic cylinder of the steering system, and the steering actuator for controlling the position of the hydraulic cylinder or other member of the steering system, in response to commands from the processor 212. Although the steering system may use digital messages (e.g., logic level signals) to control steering, in some example embodiments the steering system may use analog signals, particularly if the steering system is configured to directly communicate with the processor 212.

According to some example embodiments, the pedal actuator may mechanically move the acceleration pedal and/or the brake pedal of the leader vehicle 110 in either direction (e.g., in or out) in an amount corresponding to a speed adjustment value included in a command from the processor 212. For example, the mechanical control system 220 may include a braking system, such as a hydraulic braking system, an electro-hydraulic braking system, an electromechanical braking system, an electromechanical actuator, an electrical braking system, a brake-by-wire braking system or another braking system with an electrical or electronic control interface for communicating with the processor 212. In some example embodiments, the electronic control interface may include a sensor for detecting a position of a hydraulic cylinder of the braking system, and the pedal actuator for controlling or modulating the position of the hydraulic cylinder or other member of the braking system, in response to commands from the processor 212. Although the braking system may use digital messages (e.g., logic level signals) to control braking, in some example embodiments the braking system may use analog signals, particularly if the braking system is configured to directly communicate with the processor 212.

The mechanical control system 220 may include a propulsion system having an engine controller and a motive system (e.g., an internal combustion engine, an electric motor, etc.). The engine controller may control a throttle setting, carburetor, fuel injection system, fuel-metering system or air-metering system, or other fuel delivery system for the internal combustion engine, for example. The propulsion system may include an electric motor, a drive motor, an alternating current motor, an induction motor, a permanent magnet motor, a direct current motor, or another suitable motor for propelling a vehicle. Further, the propulsion system may include a motor controller (e.g., an inverter, chopper, wave generator, variable frequency oscillator, variable current Supply, or variable Voltage Supply) for controlling the Velocity, torque, and direction of rotation of the motor shaft of the electric motor. In some example embodiments, the propulsion system may include a hybrid drive system, a parallel hybrid, system, or a series hybrid system, in which at least one of an electric motor and an internal combustion engine can propel the vehicle. For example, in a parallel hybrid system, the electric motor, the internal combustion engine or both may apply power to one or more support structures (e.g. wheels or tracks) of the leader vehicle 110. For a series hybrid system, the electric motor typically provides power to one or more support structures (wheels or tracks) of the leader vehicle 110. The engine controller may control the motive system in response to commands from the processor 212.

According to some example embodiments, the implement actuator may mechanically move an implement attached to the leader vehicle 110 to perform a corresponding operation (e.g., tilling, planting, spraying, harvesting, etc.) based on one or more commands from the processor 212. For example, the mechanical control system 220 may include an implement system, such as a hydraulic implement system, an electro-hydraulic implement system, an electromechanical implement system, an electromechanical actuator, an electrical implement system, a drive-by-wire implement system or another implement system with an electrical or electronic control interface for communicating with the processor 212. In some example embodiments, the electronic control interface may include a sensor for detecting a position of a hydraulic cylinder of the implement system, and the implement actuator for controlling the position of the hydraulic cylinder or other member of the implement system, in response to commands from the processor 212. Although the implement system may use digital messages (e.g., logic level signals) to control the implement, in some example embodiments the implement system may use analog signals, particularly if the implement system is configured to directly communicate with the processor 212.

The UI 222 (e.g., the on-board user interface 156) may include one or more devices for communicating information to, and/or receiving information from, an operator of the leader vehicle 110. The UI 222 may include a touch screen display, but is not limited thereto and may include any device, or combination of devices, for inputting and outputting information. Information displayed on the UI 222 may be received from the processor 212, and information input to the UI 222 may be provided to the processor 212 and/or the memory 214.

The communication system 224 may transmit and/or receive communication signals to and/or from other devices (e.g., the follower vehicle 120). For example, the communication system 224 may transmit a communication signal to the follower vehicle 120 via a communication link 205 under control of the processor 212. The communication signal may include a current position (e.g., a most recently detected position) of the leader vehicle 110. The current position may be represented by two-dimensional coordinates (e.g., Northing and Easting) obtained from the positioning system 216. According to some example embodiments, the communication signal may also include one or more of a time corresponding to the current position of the leader vehicle 110, a heading of the leader vehicle 110, a velocity of the leader vehicle 110 and/or a yaw rate of the leader vehicle 110. According to some example embodiments, the communication system 224 may include a transceiver capable of both transmitting and receiving, however some example embodiments are not limited thereto. For example, according to some example embodiments, the communication system 224 include a transmitter only capable of transmitting communication signals. According to some example embodiments, the communication link 205 may be a wireless communication link between the leader vehicle 110 and the follower vehicle 120. For example, the wireless communication link 205 may be a Wi-Fi link, however, some example embodiments are not limited thereto. According to some example embodiments, the wireless communication link 205 may be any wireless link (e.g., a cellular link, a satellite link, etc.). According to some example embodiments, the communication system 224 may be implemented using processing circuitry.

The follower vehicle 120 may include a processor 232, a memory 234, a positioning system 236, a perception system 238, a mechanical control system 240, a user interface (UI) 242 and/or a communication system 244 (collectively referred to herein as the components of the follower vehicle 120). According to some example embodiments, the follower vehicle 120 may include more or fewer components than those discussed above. Corresponding descriptions of the processor 232, the memory 234, the positioning system 236, the perception system 238, the mechanical control system 240, the UI 242 and/or the communication system 244 may be the same as (or similar to) those of the processor 212, the memory 214, the positioning system 216, the perception system 218, the mechanical control system 220, the UI 222 and/or the communication system 224, respectively, and redundant description may be omitted.

The processor 232 may control overall operations of the follower vehicle 120. The processor 232 may receive a current position of the follower vehicle 120 from the positioning system 236. The communication system 244 may transmit and/or receive communication signals to and/or from other devices (e.g., the leader vehicle 110). For example, the communication system 244 may receive a communication signal from the leader vehicle 110 via the communication link 205 under control of the processor 232. The communication signal may include a current position (e.g., a most recently detected position) of the leader vehicle 110. According to some example embodiments, the communication signal may also include one or more of a time corresponding to the current position of the leader vehicle 110, a heading of the leader vehicle 110, a velocity of the leader vehicle 110 and/or a yaw rate of the leader vehicle 110. According to some example embodiments, the communication system 244 may include a transceiver capable of both transmitting and receiving, some example embodiments are not limited thereto. For example, according to some example embodiments, the communication system 224 may be a receiver only capable of receiving communication signals.

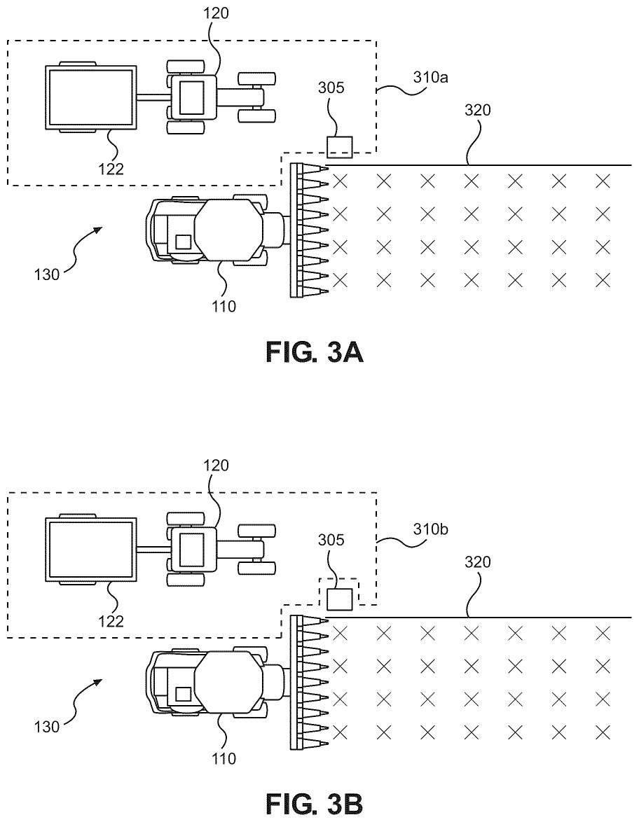

FIGS. 3A and 3B illustrate example scenarios of operating boundary generation by a follower vehicle following a leader vehicle.

Referring to FIG. 3A, in an example scenario, the leader vehicle 110 (e.g., a harvester) may be traveling in a first direction (e.g., the first direction D1) in a work area 130 (e.g., a field). In order to enable the follower vehicle 120 to receive material (e.g., harvested agricultural material) from the leader vehicle 110 while the leader vehicle 110 continues to travel (and harvest), the follower vehicle 120 may be guided to a position relative to the leader vehicle 110 (also referred to herein as the “first position”). In some examples, the first position may be a position at which an outlet of the auger 112 is positioned over the open container 122. However, some examples are not limited thereto, and the first position may be any position relative to the leader vehicle 110 that permits the transfer of material from the leader vehicle 110 to the follower vehicle 120 while both the leader vehicle 110 and the follower vehicle are moving (e.g., both moving in the first direction D1). Also, in implementations in which the operations performed do not involve material transfer, the first position may be any position (e.g., any defined position) relative to the leader vehicle 110 sufficient to enable the performance of the operations. As should be understood, since the first position is a position relative to the leader vehicle 110, a geographic location of the first position may change as the leader vehicle 110 travels.

Current systems and methods for guiding the follower vehicle 120 to the first position generate an operating boundary around the follower vehicle 120 based on the position of the leader vehicle 110 relative to the follower vehicle 120, and characteristics of the leader vehicle 110 and the follower vehicle 120. For example, the operating boundary may be generated as a closed polygon around the follower vehicle 120 that represents a region in which the follower vehicle 120 may safely perform an operation (e.g., an agricultural and/or industrial operation) without colliding with another object (e.g., the leader vehicle 110, a component of the leader vehicle 110 (such as a header, etc.), a crop, etc.). The operating boundary is defined relative to the leader vehicle 110, and thus, the operating boundary moves as the leader vehicle 110 travels through the work area 130. Since the characteristics of the leader vehicle 110 and the follower vehicle 120 do not change, the operating boundary (e.g., the dimensions and/or position relative to the follower vehicle 120) may be static.

As illustrated in FIG. 3A, the operating boundary 310a is generated to avoid a header of the leader vehicle 110 and an area in front of the header (e.g., a crop 320). However, the current devices and methods are unable to generate the operating boundary 310a to avoid an obstacle 305. For example, the obstacle 305 may represent a boulder, a fence, another vehicle, a waterway, a tree, etc. The information based on which the operating boundary 310a is generated (e.g., the position of the leader vehicle 110 relative to the follower vehicle 120, and the characteristics of the leader vehicle 110 and the follower vehicle 120) by the current devices and methods does not include an indication of the obstacle 305. Accordingly, the conventional devices and methods fail to detect the obstacle 305, and as a result, the operating boundary 310a generated fails to exclude (or reduce an overlap with) a region containing the obstacle 305. Therefore, according to the current devices and methods, the follower vehicle 120 collides with other objects (e.g., the obstacle 305) at an excessive rate causing damage to the follower vehicle 120, crops and/or soil, other machinery (e.g., other vehicles), and /r other physical objects in the work area 130 (e.g., fences, etc.).

However, according to example embodiments, improved devices and methods are provided for generating an operating boundary. For example, the processor 232 may generate the operating boundary based on perception information obtained from the perception system 238. The perception information may include a point cloud representing a position(s) of any nearby object(s) (e.g., obstacle(s)). The processor 232 may generate the operating boundary based on the position of the leader vehicle 110 relative to the follower vehicle 120, the characteristics of the leader vehicle 110 and the follower vehicle 120, and the perception information. Accordingly, the operating boundary generated by the processor 232 excludes (or reduces an overlap with) a region containing an obstacle. Therefore, the improved devices and methods overcome the deficiencies of the current devices and methods to at least avoid (or reduce the occurrence of) collisions between the follower vehicle 120 and other objects (e.g., obstacles), other machinery (e.g., other vehicles), and /r other physical objects in the work area 130 (e.g., fences, etc.).

Referring to FIG. 3B, according to some example embodiments, the processor 232 may generate the operating boundary 310b based on the position of the leader vehicle 110 relative to the follower vehicle 120, the characteristics of the leader vehicle 110 and the follower vehicle 120, and the perception information. In contrast to the operating boundary 310a discussed above in connection with FIG. 3A, the operating boundary 310b excludes (or reduces an overlap with) a region containing the obstacle 305. Accordingly, the generated operating boundary 310b prevents the follower vehicle 120 from colliding with the obstacle 305, or reduces the likelihood thereof.

According to some example embodiments, the processor 232 may determine a position of the follower vehicle 120 relative to a position of the leader vehicle 110 (hereinafter referred to as the relative position) based on first position data of the leader vehicle 110 (received via the communication system 244) and second position data of the follower vehicle 120 (obtained from the positioning system 236). The first and second position data may be captured (e.g., by the positioning system 216 and the positioning system 236, respectively) simultaneously, contemporaneously, or nearly simultaneously (e.g., the first position data may be delayed by an amount of time taken to communicate the first position data to the follower vehicle 120). According to some example embodiments, the processor 232 may determine the relative position as a difference between coordinates representing the first position data and coordinates representing the second position data. According to some example embodiments, the relative position may be defined by a distance between the leader vehicle 110 and the follower vehicle 120, and an angular bearing with reference to the leader vehicle 110, but some example embodiments are not limited thereto. According to some example embodiments, the above-described process of determining the relative position may be referred to as Machine Sync and may be implemented as described further in U.S. Pat. No. 8,060,283 hereby incorporated by reference herein.

According to some example embodiments, the processor 232 may define a Leader-Fixed Coordinate System (LFCS) with respect to the leader vehicle 110. According to some example embodiments, the processor 232 may define the LFCS such that the leader vehicle 110 is assigned a fixed position within the LFCS that does not change as the geographical position of the leader vehicle 100 changes. For example, the processor 232 may define the LFCS such that the current position of the leader vehicle 110 is assigned to a center position (e.g., having a Northing coordinate of zero and an Easting coordinate of zero) of the LFCS, but some example embodiments are not limited thereto. The processor 232 may determine the position of the follower vehicle 120 relative to the leader vehicle 110 in the context of the LFCS. For example, the processor 232 may determine current coordinates of the follower vehicle 120 within the LFCS based on the differences between absolute geographic coordinates in the first position data and the second position data. In a scenario in which the current position of the leader vehicle 110 is assigned to the center position of the LFCS, the current position of the follower vehicle 120 may be assigned a first coordinate (e.g., a Northing coordinate) equal to a difference between first coordinates (e.g., Northing coordinates) included in the first position data and the second position data, and may be assigned a second coordinate (e.g., an Easting coordinate) equal to a difference between second coordinates (e.g., Easting coordinates) included in the first position data and the second position data. According to some example embodiments, as the position of the follower vehicle 120 relative to the position of the leader vehicle 110 changes, the coordinates of the follower vehicle 120 may change. However, in circumstances in which the position of the follower vehicle 120 relative to the position of the leader vehicle 110 does not change, the coordinates of the follower vehicle 120 may not change even as the absolute geographic position of the follower vehicle 120 (and leader vehicle 110) changes.

According to some example embodiments, the processor 232 may estimate the current position of the leader vehicle 110 (e.g.,. for use in defining the LFCS) based on the first position data by accounting for a communication delay (e.g., latency) between the leader vehicle 110 and the follower vehicle 120. For example, the processor 232 may determine (e.g., calculate) the delay based on a difference between the timestamps included in the first position data and the second position data. The processor 232 may estimate the current position of the leader vehicle 110 based on the determined delay and one or more among the position of the leader vehicle 110, the heading of the leader vehicle 110, the velocity of the leader vehicle 110 and/or the yaw rate of the leader vehicle 110 included in the first position data. For example, the processor 232 may estimate the current position of the leader vehicle 110 by extrapolating where the leader vehicle 110 would travel during the amount of time represented by the determined delay based on the first position data. The processor 232 may define the LFCS based on this estimated current position of the leader vehicle 110, and may determine current coordinates of the follower vehicle 120 within the LFCS as discussed above.

According to some example embodiments, the processor 232 may determine an initial operating boundary based on the relative position (e.g., as defined in the LFCS), along with characteristics of the leader vehicle 110 and the follower vehicle 120. As discussed herein, the characteristics of the leader vehicle 110 and the follower vehicle 120 include those which define an interfering area(s) and a non-interfering area(s). For example, an interfering area may be an area in the vicinity of a first vehicle which, if occupied by a second vehicle, would result in a collision between the first and second vehicles or otherwise interfere with an operation being performed by the first vehicle (e.g., an agricultural and/or industrial operation). As such, a non-interfering area may be an area in the vicinity of the first vehicle which, if occupied by the second vehicle, would not result in a collision between the first and second vehicles and would not otherwise interfere with an operation being performed by the first vehicle. With reference to FIG. 3B, for example, the area occupied by the header of the leader vehicle 110, and the area directly in front of the header of the leader vehicle 110 in which the leader vehicle 110 is performing a harvesting operation, may represent interfering areas of the leader vehicle 110.

Interfering and non-interfering areas of a specific vehicle may vary based on the characteristics of the specific vehicle. For example, different vehicles may have different structures (e.g., headers, augers, attached implements, etc.) that occupy interfering areas. Also, different vehicles may perform different operations (e.g., harvesting, spraying, seeding, etc.) that would each involve a corresponding interfering area. Non-interfering areas may be any areas that are not interfering areas. According to some example embodiments, the interfering areas and/or non-interfering areas particular to each type of vehicle may be predefined (or alternatively, given). According to some example embodiments, the interfering areas and/or non-interfering areas of the follower vehicle 120 may be pre-stored (or stored) in the memory 234. According to some example embodiments, the follower vehicle 120 may receive the interfering areas and/or non-interfering areas of the leader vehicle 110 from the leader vehicle 110 via the communication link 205, but some example embodiments are not limited thereto. According to some example embodiments, the follower vehicle 120 may receive an indication of the vehicle type of the leader vehicle 110 from the leader vehicle 110 via the communication link 205, and may determine the interfering areas and/or non-interfering areas of the leader vehicle 110 based on corresponding information pre-stored (or stored) in the memory 234 in association with the indicated vehicle type.

According to some example embodiments, the processor 232 may determine (and/or generate) the initial operating boundary as a boundary around the follower vehicle 120 that excludes (or reduces a region of overlap with) any region in which the interfering area(s) of the follower vehicle 120 would overlap with the interfering area(s) of the leader vehicle 110 based on the relative position. According to some example embodiments, a portion of the initial operating boundary separating the interfering area(s) of the follower vehicle 120 from the interfering area(s) of the leader vehicle 110 may be determined to permit a tolerance or margin of error represented by a first buffer distance between the interfering area(s) of the follower vehicle 120 from the interfering area(s) of the leader vehicle 110. According to some example embodiments, the first buffer distance may be a design parameter determined through empirical study, but some example embodiments are not limited thereto. According to some example embodiments, the first buffer distance may be input by an operator of the follower vehicle 120 (e.g., via the UI 242). The tolerance/margin of error may reflect a degree of reliability that the interfering area(s) of the follower vehicle 120 will not overlap the interfering area(s) of the leader vehicle 110.

According to some example embodiments, the initial operating boundary may be a closed boundary surrounding the follower vehicle 120, but some example embodiments are not limited thereto. According to some example embodiments, the initial operating boundary may be defined in an interior region between the follower vehicle 120 and leader vehicle 110, and may be open toward the front (e.g., in the first direction D1) and/or rear (e.g., in a direction opposite to the first direction D1) of the follower vehicle 120. According to some example embodiments, the initial operating boundary may be in the form of a polygon, but some example embodiments are not limited thereto and the initial operating boundary may be in the form of any shape. According to some example embodiments, the initial operating boundary may be straight or curved, and/or continuous or discontinuous.

According to some example embodiments, the processor 232 may determine (and/or generate) a final operating boundary based on the initial operating boundary and the perception information. For example, the perception information may include a point cloud representing a position(s) of any nearby object(s) (e.g., obstacle(s)). According to some example embodiments, the processor 232 may determine the final operating boundary by excluding (or reducing a region of overlap with) any region containing a nearby object represented in the point cloud. According to some example embodiments, the processor 232 may analyze the point cloud data to identify one or more objects that may interfere with and/or obstruct the follower vehicle 120 as it travels or performs an operation (e.g., an agricultural or industrial operation). Such objects are herein referred to as obstacles. For example, the processor 232 may compare a size of an object with a size threshold and/or compare a height of the object with a height range. According to some example embodiments, the processor 232 may determine that an object having a size greater than or equal to the size threshold is an obstacle. According to some example embodiments, the processor 232 may determine that an object having a height at least partially within the height range is an obstacle. For example, the height range may correspond to a height of the follower vehicle 120 (including any attached implements), and the height range may be used to exclude objects positioned higher than the follower vehicle 120 (e.g., tree branches, etc.) from consideration as obstacles. According to some example embodiments, the processor 232 may determine that an object having a size greater than or equal to the size threshold and having a height at least partially within the height range is an obstacle. According to some example embodiments, each of the size threshold and the height range may be a design parameter determined through empirical study, but some example embodiments are not limited thereto. According to some example embodiments, each of the size threshold and the height range may be input by an operator of the follower vehicle 120 (e.g., via the UI 242). The final operating boundary determined by the processor 232 may represent the operation boundary 310b.

According to some example embodiments, a portion of the final operating boundary bordering the obstacle may be determined (and/or generated) to permit a tolerance or margin of error represented by a second buffer distance from the obstacle. According to some example embodiments, the second buffer distance may be a design parameter determined through empirical study, but some example embodiments are not limited thereto. The tolerance/margin of error may reflect a degree of reliability that the interfering area(s) of the follower vehicle 120 will not overlap the interfering area(s) of the leader vehicle 110 and/or the area of the obstacle. According to some example embodiments, the second buffer distance may be input by an operator of the follower vehicle 120 (e.g., via the UI 242). According to some example embodiments, similar to the initial operating boundary, the final operation boundary may be a closed boundary surrounding the follower vehicle 120, but some example embodiments are not limited thereto. According to some example embodiments, the final operating boundary may be defined in an interior region between the follower vehicle 120 and leader vehicle 110, and may be open toward the front and/or rear of the follower vehicle 120. According to some example embodiments, the final operating boundary may be in the form of a polygon, but some example embodiments are not limited thereto and the final operating boundary may be in the form of any shape. According to some example embodiments, the final operating boundary may be straight or curved, and/or continuous or discontinuous.

The above discussion of the determination of operating boundary 310b describes separate determinations of the initial operating boundary and the final operating boundary, but some example embodiments are not limited thereto. According to some example embodiments, the processor 232 may determine the operating boundary 310b (e.g., the final operating boundary) based on the relative position, the characteristics of the leader vehicle 110 and the follower vehicle 120, and the perception information, using operations similar to those discussed above, without the intermediate operation of determining the initial operating boundary.

According to some example embodiments, the processor 232 may guide and/or control the follower vehicle 120 based on the determined/generated operating boundary 310b. For example, the processor 232 may control the steering actuator to change a steering angle of the follower vehicle 120 (e.g., change the position of the hydraulic cylinder of the steering system) to remain within the operating boundary 310b. According to some example embodiments, in response to determining that the follower vehicle 120 (or an interfering region of the follower vehicle 120) will overlap with the operating boundary 310b along a current path of travel, the processor 232 may control the steering actuator to change a steering angle of the follower vehicle 120. For example, in response to determining the overlap will occur to a right side (e.g., a second direction D2 illustrated in FIG. 1B) of the follower vehicle 120, the processor 232 may control the steering actuator to change the steering angle to steer the follower vehicle 120 to the left. Also, in response to determining the overlap will occur to a left side (e.g., a direction opposite to the second direction) of the follower vehicle 120, the processor 232 may control the steering actuator to change the steering angle to steer the follower vehicle 120 to the right. According to some example embodiments, the processor 232 may control an actuation magnitude of the steering actuator (e.g., a distance by which the position of the hydraulic cylinder of the steering system will be moved) to change the steering angle to a more severely (e.g., move the hydraulic cylinder by a greater distance) in scenarios in which the region of overlap is closer to a current position of the follower vehicle 120.

According to some example embodiments, the processor 232 may control the pedal actuator to change a travel speed of the follower vehicle 120 (e.g., change the position of the hydraulic cylinder of the braking system) to remain within the operating boundary 310b. According to some example embodiments, in response to determining that the follower vehicle 120 (or an interfering region of the follower vehicle 120) will overlap with the operating boundary 310b along a current path of travel, the processor 232 may control the pedal actuator to reduce the travel speed of the follower vehicle 120. According to some example embodiments, the processor 232 may control the pedal actuator to reduce the travel speed in response to determining that the operating boundary 310b narrows along a current path of travel (e.g., a path between two obstacles). According to some example embodiments, the processor 232 may control an actuation magnitude (e.g., a distance by which the position of the hydraulic cylinder of the braking system will be moved) of the pedal actuator to reduce the travel speed faster (e.g., move the hydraulic cylinder by a greater distance and/or more quickly) in scenarios in which the region of overlap, or the region of narrowing, is closer to a current position of the follower vehicle 120.

According to some example embodiments, the processor 232 may control the implement actuator to change a position of an implement (e.g., an auger, etc.) to remain within the operating boundary 310b (e.g., change the position of the hydraulic cylinder of the implement system). According to some example embodiments, in response to determining that an interfering region of the follower vehicle 120 corresponding with the implement will overlap with the operating boundary 310b along a current path of travel, the processor 232 may control the implement actuator to change a position of the implement. For example, the processor 232 may control the implement actuator to retract the implement inward towards the follower vehicle 120. According to some example embodiments, the processor 232 may control an actuation magnitude (e.g., a distance by which the position of the hydraulic cylinder of the implement system will be moved) of the implement actuator to change the position of the implement faster (e.g., move the hydraulic cylinder by a greater distance and/or more quickly) in scenarios in which the region of overlap is closer to a current position of the follower vehicle 120.

According to some example embodiments, the above operations for determining the operating boundary 310b may be performed continuously and/or periodically. Accordingly, the operating boundary 310b may be dynamically determined/generated to account for obstacles 305 detected throughout an operation performed in the work area 130 by the follower vehicle 120 (e.g., an agricultural and/or industrial operation such as harvesting, planting, seeding, tilling, spraying, etc.). According to some example embodiments, the follower vehicle 120 (and/or the leader vehicle 110) may guide the follower vehicle 120 based on the operating boundary 310b while following a path or attempting to travel to a target position (e.g., the first position relative to the leader vehicle 110 discussed above). Accordingly, the discussion above regarding the actuation magnitude controlled by the processor 232 with respect to the steering actuator, the pedal actuator and/or the implement actuator may represent a balance between the aggressiveness of the path following (and/or position targeting) and the proximity of the obstacles 305 to the operating boundary 310b. For example, in a scenario in which there are no obstacles 305 proximate to the operating boundary 310b, the processor 232 may control the follower vehicle 120 to follow the path (or target the position) more aggressively. However, in a scenario in which one or more obstacles 305 are proximate to the operating boundary 310b, the processor 232 may control the follower vehicle 120 to follow the path (or target the position) less aggressively while avoiding the one or more obstacles 305 (e.g. by effecting an actuation magnitude that increases as proximity to the one or more obstacles 305 increases), as discussed above.

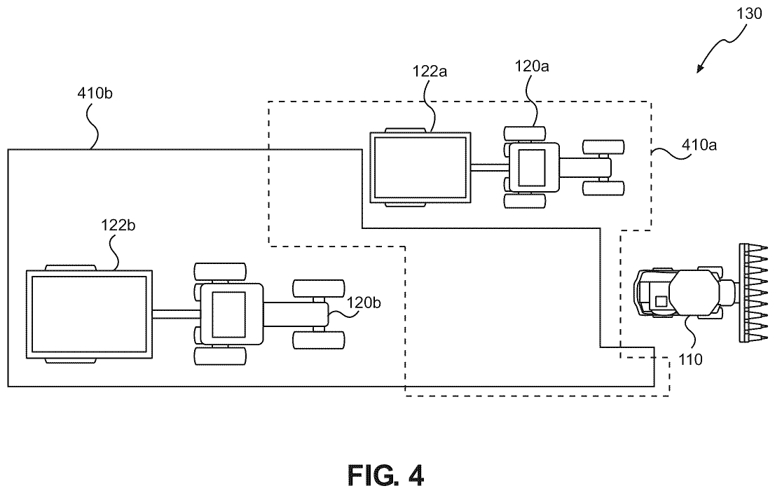

FIG. 4 illustrates a scenario for collaborative operations with multiple vehicles including two or more follower vehicles, according to some example embodiments.

Referring to FIG. 4, a collaborative (may also be referred to herein as coordinated and/or cooperative) operation (e.g., an agricultural and/or industrial operation) may be performed by the leader vehicle 110, a first follower vehicle 120a and a second follower vehicle 120b. In this scenario, each of the first follower vehicle 120a and the second follower vehicle 120b includes an open container 122a and 122b, respectively, but some example embodiments are not limited thereto. According to some example embodiments, each of the first follower vehicle 120a and the second follower vehicle 120b may be the same as, or similar to, the follower vehicle 120 discussed herein.

According to some example embodiments, each of the first follower vehicle 120a and the second follower vehicle 120b may determine/generate a corresponding operating boundary according to the operations discussed herein. For example, the first follower vehicle 120a may generate a first operating boundary 410a, and the second follower vehicle 120b may generate a second operating boundary 410b. According to some example embodiments, each of the first follower vehicle 120a and the second follower vehicle 120b may generate/determine the first operating boundary 410a and the second operating boundary 410b, respectively, without communicating with one another. For example, the first follower vehicle 120a may generate the first operating boundary 410a by considering the second follower vehicle 120b as an obstacle (e.g., by detecting the second follower vehicle 120b using the perception information, and determining the second follower vehicle 120b to be an obstacle), and the second follower vehicle 120b may generate the second operating boundary 410b by considering the first follower vehicle 120a as an obstacle (e.g., by detecting the first follower vehicle 120a using the perception information, and determining the first follower vehicle 120a to be an obstacle).

Current devices and methods for coordinating operations between multiple vehicles are unable to perform such operations involving the coordination of multiple follower vehicles due, for example, to the lack of communication between the vehicles regarding the characteristics of the vehicles. However, according to example embodiments, improved devices and methods are provided for coordinating such operations. For example, as described above, multiple follower vehicles may perform the operations by considering one another as obstacles, and generating respective operating boundaries as described herein. Accordingly, the improved devices and methods overcome the deficiencies of the current devices and methods to enable the coordination of multiple follower vehicles without the follower vehicles communicating their respective characteristics to one another.

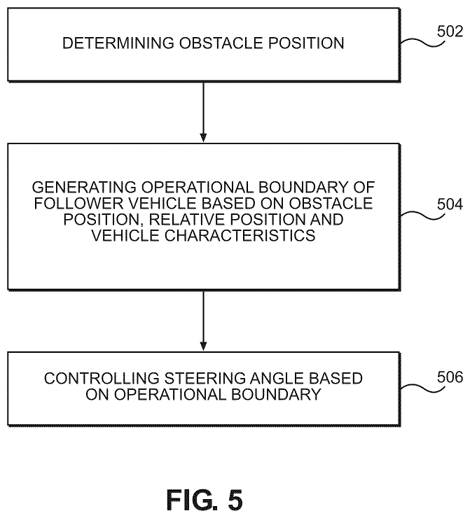

FIG. 5 illustrates a method for generating an operating boundary of a follower vehicle, according to some example embodiments. According to some example embodiments, the method may be performed by the processor 232.

Referring to FIG. 5, in operation 502, the method may include determining a position of an obstacle to a follower vehicle. For example, the position of the obstacle may be determined using a LiDAR system and/or a camera system as discussed further herein. According to some example embodiments, the obstacle may be a boulder, a fence, a tree, a waterway, another follower vehicle, etc.

In operation 504, the method may include generating an operating boundary of the follower vehicle based on the position of the obstacle, a relative position of the follower vehicle to a leader vehicle, and characteristics of the follower vehicle and the leader vehicle. According to some example embodiments, operation 504 may include generating the operating boundary to exclude a region occupied by the obstacle, a region occupied by a structure of the leader vehicle, and/or a region used by the leader vehicle to perform an operation, as discussed further herein. According to some example embodiments, the operating boundary may be continuous and may surround the follower vehicle.

In operation 506, the method may include controlling a steering angle of a steering actuator based on the operating boundary. According to some example embodiments, operation 506 may include controlling the steering angle of the steering actuator to steer the follower vehicle 120 to remain within the operating boundary, as discussed further herein.

As discussed above, operations 502, 504 and 506 may be performed iteratively throughout an operation of the follower vehicle 120 (e.g., an agricultural and/or industrial operation) to dynamically generate the operating boundary, and to control the follower vehicle 120 to remain within the operating boundary throughout the operation.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm and functions described in connection with some example embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 214 and the memory 234).

According to some example embodiments, the memory 214 and the memory 234 may each be a tangible, non-transitory computer-readable medium, such as a Random Access Memory (RAM), a flash memory, a Read Only Memory (ROM), an Electrically Programmable ROM (EPROM), an Electrically Erasable Programmable ROM (EEPROM), registers, a hard disk, a removable disk, a Compact Disk (CD) ROM, any combination thereof, or any other form of storage medium known in the art.

Some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

It will be understood that when an element is referred to as being “connected” or “coupled” to another element, it may be directly connected or coupled to the other element or intervening elements may be present. As used herein the term “and/or” includes any and all combinations of one or more of the associated listed items.

Although terms of “first” or “second” may be used to explain various components (or parameters, values, etc.), the components (or parameters, values, etc.) are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

1. A follower vehicle, comprising:
a steering actuator; and
processing circuitry configured to cause the follower vehicle to
determine a position of an obstacle to the follower vehicle,
generate an operating boundary of the follower vehicle based on the position of the obstacle, a relative position of the follower vehicle to a leader vehicle, and characteristics of the follower vehicle and the leader vehicle, and
control a steering angle of the steering actuator based on the operating boundary.

2. The follower vehicle of claim 1, wherein the processing circuitry is configured to determine the position of the obstacle using a LiDAR system or a camera system.

3. The follower vehicle of claim 1, wherein the processing circuitry is configured generate the operating boundary to exclude one or more of:
a region occupied by the obstacle;
a region occupied by a structure of the leader vehicle; or
a region used by the leader vehicle to perform an operation.

4. The follower vehicle of claim 1, wherein the operating boundary is continuous and surrounds the follower vehicle.

5. The follower vehicle of claim 1, wherein the obstacle is a boulder, a fence, a tree or a waterway.

6. The follower vehicle of claim 1, wherein the obstacle is another follower vehicle.

7. The follower vehicle of claim 1, wherein the processing circuitry is configured to control the steering angle of the steering actuator to steer the follower vehicle to remain within the operating boundary.

8. A method, comprising:
determining a position of an obstacle to a follower vehicle;
generating an operating boundary of the follower vehicle based on the position of the obstacle, a relative position of the follower vehicle to a leader vehicle, and characteristics of the follower vehicle and the leader vehicle; and
controlling a steering angle of a steering actuator based on the operating boundary.

9. The method of claim 8, wherein the determining comprises determining the position of the obstacle using a LiDAR system or a camera system.

10. The method of claim 9, wherein the generating comprises generating the operating boundary to exclude one or more of:
a region occupied by the obstacle;
a region occupied by a structure of the leader vehicle; or
a region used by the leader vehicle to perform an operation.

11. The method of claim 8, wherein the operating boundary is continuous and surrounds the follower vehicle.

12. The method of claim 8, wherein the obstacle is a boulder, a fence, a tree or a waterway.

13. The method of claim 8, wherein the obstacle is another follower vehicle.

14. The method of claim 8, wherein the controlling comprises controlling the steering angle of the steering actuator to steer the follower vehicle to remain within the operating boundary.

15. A non-transitory computer-readable medium storing instructions that, when executed by at least one processor of a follower vehicle, cause the at least one processor to perform a method, the method comprising:
determining a position of an obstacle to the follower vehicle;
generating an operating boundary of the follower vehicle based on the position of the obstacle, a relative position of the follower vehicle to a leader vehicle, and characteristics of the follower vehicle and the leader vehicle; and
controlling a steering angle of a steering actuator based on the operating boundary.

16. The non-transitory computer-readable medium of claim 15, wherein the determining comprises determining the position of the obstacle using a LiDAR system or a camera system.

17. The non-transitory computer-readable medium of claim 16, wherein the generating comprises generating the operating boundary to exclude one or more of:
a region occupied by the obstacle;
a region occupied by a structure of the leader vehicle; or
a region used by the leader vehicle to perform an operation.

18. The non-transitory computer-readable medium of claim 15, wherein the operating boundary is continuous and surrounds the follower vehicle.

19. The non-transitory computer-readable medium of claim 15, wherein the obstacle is a boulder, a fence, a tree, a waterway or another follower vehicle.

20. The non-transitory computer-readable medium of claim 15, wherein the controlling comprises controlling the steering angle of the steering actuator to steer the follower vehicle to remain within the operating boundary.
